(19) United States
(12) Patent Application Publication
(10) Pub. No.: US 2025/0281260 A1
(43) Pub. Date: Sep. 11, 2025

(54) System and Method for Root Canal Treatment

(71) Applicant: Pac-Dent, Inc., Brea, CA (US)

(72) Inventor: Carlos Alberto Spironelli Ramos, Henderson, NV (US)

(73) Assignee: Pac-Dent, Inc., Brea, CA (US)

(21) Appl. No.: 19/217,769

(22) Filed: May 23, 2025

Related U.S. Application Data
(63) Continuation of application No. 17/741,338, filed on May 10, 2022.

(51) Int. Cl. A61C 1/07; A61C 5/40; A61C 17/02; A61C 17/08

(52) U.S. Cl. CPC A61C 1/07; A61C 5/40; A61C 17/0208; A61C 17/08

(57) ABSTRACT

An endodontic microcannula system for evacuation of root canal contents from a root canal of a patient. The system includes a microcannula for insertion into the root canal, a handpiece for vibrating the microcannula while it is disposed within the root canal, and an irrigation fluid reservoir for supplying irrigation fluid to the root canal, an a vacuum source for drawing the fluid and root canal debris into the microcannula and out of the root canal.

### FIELD OF THE INVENTION

The present invention is in the field of endodontics. More particularly, the present invention relates to methods and apparatus used during root canal procedures. Specifically, to an ultrasonic tip and connector insert useful for negative pressure irrigation and activation of irrigants for cleaning root canals.

### BACKGROUND INFORMATION

Endodontic treatment is aimed at chemo-mechanically minimizing microorganisms, inactivating their by-products, and optimally sealing the canal space to prevent future recontamination of the canal space. If root canals could be thoroughly cleaned using irrigation alone, and then effectively obturated, there would be no need for mechanical instrumentation.

The initial cleaning of root canals is commonly performed by mechanical instrumentation, which removes the large bulk of the pulp tissue, the necrotic debris, and bacterial biofilms or a previous root filling. Unless this bulk of material is first removed, no further cleaning is possible. Mechanical instrumentation is performed by using either stainless steel hand files or engine-driven nickel-titanium (NiTi) rotary and/or reciprocation files, neither of which is expected to completely clean the canal when used alone but will create a “space” that will be filled by irrigation liquid to provide the cleaning effect. A substantial part of the root canal wall is left untouched by contemporary instrumentation techniques, and irrigation may be considered the primary method to clean and disinfect these areas of the root canal system Nevertheless, it is recognized that cleaning and disinfecting the apical part of the canal with irrigants (e.g., sodium hypochlorite) is ineffective unless the canal is enlarged properly. Various irrigation chemicals, techniques, and devices are being used together with mechanical instrumentation to improve the cleaning and disinfection of root canal systems.

Traditionally, the chemo-mechanical preparation of root canals has included the use of a conventional endodontic syringe and an open-or closed-ended cannula for irrigation. This technique is the most widely used because it doesn't need any special device to operate and allows reasonable control of cannula depth and volume of irrigation liquid delivered.

The high flow rate used to introduce the irrigant into the canal and cannula wedging results in technique-related factors that increase irrigation liquid pressure at the apical portion of the canal when open-ended cannulas are used, which can sometimes extrude the solution periapically, resulting in tissue damage and postoperative pain. The true frequency of such accidents is unknown, as many of them may not be reported, while minor extrusion incidents might even remain undetected due to the absence of severe symptoms. A 2008 survey of endodontists in the United States indicated that nearly half of the respondents (42%) had experienced at least one sodium hypochlorite (NaOCl) accident during their practice careers.

Regarding its efficacy, conventional syringe and open-ended cannula irrigation leaves a large number of debris clogged in the irregularities of the root canal system and does not efficiently deliver the irrigant solution into the apical third of the canal.

Closed-ended (side open) cannulas result in the development of lower liquid pressure at the apical foramen compared to open-ended cannulas, having a direct effect on dropping the irrigant flow rate, which is the most frequently reported technique-related factor in extrusion-accident case reports. The ability of clinicians to estimate irrigant flow rate inevitably relies on subjective estimation, and there is no unanimous definition of “low flow rate” or “high flow rate” in endodontic irrigation. From a safety perspective, not wedging the cannula and using a low flow rate should be done to avoid the possibility for irrigant extrusion.

The effectiveness of irrigation relies on both the mechanical flushing action and the chemical ability of irrigants to dissolve the tissue. Use of ultrasonic systems was proposed as a possible solution for cleaning the canal system, the use thereof after the mechanical preparation of the canal system has shown a reduction in the number of bacteria and endotoxins, at the same time a substantial improvement in debris removal may be achieved. Passive ultrasonic irrigation (PUI) has been introduced to increase the effectiveness of canal cleaning and disinfection by ultrasonic activation/agitation of the chemical solution (NaOCl and EDTA) inside the canal. The ultrasonic activation of irrigants creates acoustic microstreaming and transient cavitation that push the irrigant laterally into the irregularities of the canal. Acoustic microstreaming is defined as a rapid movement of fluid in a vortex motion, generating shear stresses that enhance debridement. Transient cavitation generates bubbles that, when collapsing, produce radiating shock waves and temperature rise. Using ultrasonic-assisted irrigation, the solution can access areas that were not touched by the instruments and are hardly ever reached when used in other modes due to the high surface tension of the irrigant. It has also been reported to allow better penetration into lateral canals and narrow isthmuses compared to syringe and cannula irrigation. Greater penetration of the irrigant into dentinal tubules has also been reported, even at 1 mm from the working length. The cavitation effect produced by PUI, combined with the increase in NaOCl temperature, has also resulted in better tissue dissolution.

During and after completion of mechanical preparation, PUI can be used in either intermittent or continuous mode. In the intermittent technique, the canal is first filled with the chemical solution using a syringe and cannula, and an ultrasonic tip is activated in the canal up to 1 mm from the working length. The ultrasonic tip is moved passively with an in-and-out motion to ensure that it does not bind with the root canal walls. The recommended activation protocol cycles 30 seconds after changing the instrument during the sequence of instrumentation enlargement for each canal.

Continuous ultrasonic passive irrigation (CUPI) is achieved by simultaneously and continuously delivering irrigation during ultrasonic activation through a specially designed irrigation tip, in contrast to intermittent PUI, which needs manual (syringe and cannula) replacement of the liquid inside the canal. It is well known that chlorine is responsible for the dissolution of organic tissue and the antimicrobial effect of NaoCl, and it is rapidly consumed during the first phase of tissue dissolution. Therefore, regular replenishment and large volumes of NaOCl are required. During CUPI, the volume of irrigant can be set by the operator, allowing control of irrigant volume exchange during the procedure and, more importantly, after finishing the mechanical enlargement. The chemical solution (NaOCl or EDTA) is housed in a reservoir on the ultrasonic unit itself, and will be dispensed by the unit, continuously providing new reactant for the irrigation chemical reaction.

There are two types of CUPI systems available, both related to piezo ultrasonic units. The non-apical delivering tip is based on a stainless-steel K-File or a NiTi smooth digital spreader design. In this type of delivery/activation method, the liquid comes directly from a reservoir to an exit port located at the intermediate section of the tip. The liquid navigates the surface path of the tip to its end, passively, without apical pressure. This allows the operator to insert and activate the liquid without apical pressure, preventing apical extrusion of the irrigant.

The second type of CUPI is an ultrasonic-activated open-ended cannula with a silicone tube connection that dispenses the irrigant at the open apical end of the cannula. The flow rate of the liquid is determined by using a syringe operated manually or with an optional mechanical syringe pump. The operator needs to be careful concerning the apical extrusion of the solution, especially when using NaOCl, as was discussed previously. In a study from 2012, Malentacca et al (Malentacca A, Uccioli U, Zangari D, et al. Efficacy and safety of various active irrigation devices when used with either positive or negative pressure: an in vitro study. J Endod. 2012; 38:1622-1626) showed that this form of ultrasonic activation using an apically opened cannula was dangerous if performed at a distance of less than 5 mm from the apex.

Studies demonstrated that negative pressure irrigation (NPI) is one of the most effective methods of cleaning or debriding root canals, and a safe method of applying sodium hypochlorite solution into root canals. Despite the efficacy shown, NPI systems include several design features that have severely limited their use in clinical practice. The first limiting feature is the cannula, which includes 12 micro-ports within the first 1 mm near the distal end. The ports frequently clog as dental pulp fragments and cut dentin debris are sucked into the ports during use.

The use of lasers at different wavelengths has been proposed to supplement conventional endodontic cleaning procedures. A considerable limitation, however, is the unidirectional emission of the laser beam, which makes it difficult to access the entire root canal wall with the laser. The laser fiber must be moved repeatedly in a spiraling motion along the root canal walls in order to maximize the area exposed to the laser beam, but even this is not completely efficient and the entire root canal wall will not be exposed to the laser beam Alternative approaches such as side-firing tips have limited use because of their size or require further investigation before clinical application.

Laser-activated irrigation (LAI) with an erbium laser has been introduced as a method for activating the irrigant. The effect is based on cavitation; in water, activation of the laser at subablative settings may result in the formation of large elliptical vapor bubbles, which expand and implode. These vapor bubbles may cause a volumetric expansion of 1,600 times the original volume, which increases pressure and drives fluid out of the canal. When the bubble implodes after 100 to 200 microseconds, an under pressure develops and sucks fluid back into the canal, inducing secondary cavitation effects. Therefore, the laser works as a fluid pump.

Recently, a multi-sonic system which consists of a console and a handpiece has been developed as a novel approach to clean and disinfect the root canal system. The system is composed by a series of different irrigation solutions in different time and concentration closed end cycles. The activation of the liquids is done inside the pulp chamber using ultrasonic frequencies. While in-vitro studies have demonstrated good results by the multisonic system with regards to canal cleanliness and safety, higher level evidence of the performance showed results similar to ultrasonic passive activation (PUI). Furthermore, the system cost and maintenance of laser-activated-irrigation (LAI) and multi-sonic are expensive and require the use of a new handpiece for each treatment.

The present invention attempts to address the shortcomings of current available root canal cleaning techniques and devices by using an ultrasonic activated small diameter high-performance polymer cannula to get closer to the foramen with concomitant irrigation while simultaneously removing debris particles by negative pressure.

As background information, reference may be had to U.S. Pat. No. 8,827,705 issued Sep. 9, 2014, entitled “Apparatus For Evacuation Of Root Canal” The described method device shows a system that includes a holder for a small diameter metal cannula used for apical evacuation and a syringe and cannula separately for dispensing irrigation liquid at the pulp chamber. The difference between the present invention and the aforementioned patent is that the invention is described as one single cannula that will be used both for irrigation, via an ultrasonic or sonic connector, and evacuation. Furthermore, U.S. Pat. No. 8,827,705 doesn't mention activation with ultrasonic or sonic energy.

Another example is U.S. Pub. No. 2016/0067023 entitled “Device For Endodontics By Means Of Continuous Ultrasonic Irrigation.” The described device uses continuous flow of irrigation with concomitant ultrasonic activation and suction, but is composed of three different parts, a plastic body connected to an ultrasonic dental unit, a coronal cannula for the ejection of the irrigation liquid, and a microcannula that sucks up the irrigant. The difference between the present invention and the aforementioned patent application is that the invention is described as one single cannula that will be used both for irrigation, via an ultrasonic or sonic connector, and evacuation. Furthermore, the aforementioned patent application claims a nickel-titanium metal microcannula with six openings. The present invention describes a polymer microcannula with one or more openings.

Another example is U.S. Pub. No. 2011/0020765 entitled “ULTRASONIC TIP FOR DENTAL DEVICE”. The patent application was published on Jan. 27, 2011. The described device uses a secondary pressure source for injecting irrigation fluid connected to the tip assembly. The difference between the present invention and the aforementioned patent application is that the invention as described uses a metal cannula to deliver irrigation liquid inside the canal at the very end, while the present invention uses a polymer cannula for end suction, and irrigation comes from the ultrasonic or sonic handpiece.

The present invention is an improvement on basic concepts as revealed in these and other United States patents/applications.

### SUMMARY OF THE INVENTION

The present invention addresses the prior art problems of inadequate delivery and activation of the irrigation liquid to the apical third of the canal resulting in an incomplete cleaning, and penetration of the irrigation liquid past the foramen into the periapical tissue resulting in treatment complications. The present invention offers a safer, less expensive, and effective method to continuously deliver the irrigation liquid without apical pressure, at the same time activating said liquid, and safely apically evacuate said liquid via negative pressure.

In embodiments, an endodontic micro-cannula configured for simultaneous irrigation, ultrasonic or sonic intracanal activation of an irrigant, and evacuation of root canal contents is disclosed, including an open proximal end, a distal end having at least one opening, and at least two interior lumenal diameters, where a lumenal diameter of the distal end is smaller than that of said proximal end; having a non-tapered and/or substantially tapered shape about a long axis such that a first lumen within the micro-cannula is configured to be a conduit for evacuation of root canal contents; a portion of an outer diameter adjacent to the proximal end configured to engage an attached insert of an ultrasonic or sonic handpiece; a body made of polymer materials that effectively vibrates at a frequency provided via the ultrasonic or sonic handpiece, and optionally which attached insert is configured to position an annulus formed from a second lumen within the attached insert at an oblique angle relative to the top of the open proximal end; and a tubing connector at the open proximal end configured to attach to evacuation tubing.

In one aspect, the adjacent outer diameter portion is configured to be threaded into an attached insert of the ultrasonic or sonic handpiece.

In another aspect, the distal end comprises two or more openings.

In one aspect, the micro-cannula comprises a first polymer tube attached to a second polymer tube by a means including mechanical engagement, chemical attachment, glue, over molding and combinations thereof.

In a related aspect, the first polymer tube has a first outer diameter and said second polymer tube has a second outer diameter which second outer diameter is different from the first outer diameter, and optionally where a portion of the second polymer tube covers a proximal portion of the first polymer tube via a tight superimposed connection.

In one aspect, the distal end vibrates at a resonance frequency of greater than about 6 kHz via the handpiece, which frequency provides sufficient force to transport the irrigant externally and passively through at least one opening of the distal end. In a related aspect, the resonance frequency is between about 6 and about 30 KHz.

In one aspect, the open proximal end is configured to connect to a first tubing, which first tubing is configured to connect to a suction unit attached to the ultrasonic or sonic handpiece, whereby negative pressure is created by said suction unit at the at least one distal end opening of the micro-cannula, which at least one distal end opening evacuates root canal contents as the micro-cannula is vibrating and the attached insert is irrigating the root canal via the annulus.

In another aspect, the attached connector insert is configured to contain a threaded receiving slot, and where the micro-cannula is positioned and maintained in the receiving slot by the attached insert.

In one aspect, the vibrations induced by ultrasonic or sonic energy through the micro-cannula are amplified due to free vibration at a distal end extremity.

In another aspect, the irrigant includes distilled water, tissue dissolving agents, antibacterial agents, chelating agents and combinations thereof.

In one aspect, the irrigant includes sodium hypochlorite, EDTA, ClO₂, MTAD, HEBP, citric acid, maleic acid, chlorhexidine (CHX), green tea, triphala and combinations thereof.

In embodiments, a consumable endodontic micro-cannula adapted for simultaneous irrigation, ultrasonic or sonic intracanal activation of an irrigant, and evacuation of root canal content is disclosed including, an open proximal end, an open distal end, and at least two interior lumenal diameters, where a lumenal diameter of the open distal end is smaller than that of the open proximal end; a non-tapered and/or substantially tapered shape about a long axis such that a first lumen within the micro-cannula is configured to be a conduit for evacuation of root canal contents; an outer diameter adjacent to the proximal end configured to be self-threading into an attached insert of an ultrasonic or sonic handpiece; a body made of polymer materials that effectively vibrates with a frequency provided by the ultrasonic or sonic handpiece, and which attached insert is configured to position an annulus formed from a second lumen within the attached insert at an obtuse angle relative to the top of the proximal end; and a tubing connector at the proximal end configured to attach to evacuation tubing.

In one aspect, the distal end of said micro-cannula vibrates at a resonance frequency of greater than about 6 KHz via the ultrasonic or sonic handpiece, which frequency provides sufficient force to transport the irrigant externally and passively through the distal end. In a related aspect, the resonance frequency is between about 6 and about 30 KHz.

In embodiments, an endodontic procedure is disclosed including making an opening through the crown of a tooth to enter a pulp chamber of a subject; removing infected or diseased pulp from the pulp chamber; inserting a micro-cannula connected to an ultrasonic or sonic handpiece into the pulp chamber, where the micro-cannula includes: an open proximal end, a distal end having at least one opening, and at least two interior lumenal diameters, where a lumenal diameter of the distal end is smaller than that of the open proximal end; a tapered and/or substantially tapered shape about a long axis such that a first lumen within the micro-cannula is configured to be a conduit for evacuation of root canal contents; an outer diameter adjacent to the proximal end configured to engage an ultrasonic or sonic attached insert of a handpiece; a body made of polymer materials that effectively vibrates with a frequency provided by the ultrasonic or sonic handpiece, where the attached insert is configured to position an annulus formed from a second lumen within the attached insert at an obtuse angle relative to the top of the proximal end, and where the lumen conducts irrigant from a reservoir to the root canal; and a tubing connector at the proximal end configured to attach to evacuation tubing, and applying negative pressure, irrigant and ultrasonic or sonic energy via said handpiece, where remaining root canal contents are substantially removed.

In one aspect, the adjacent outer diameter is threaded to engage the attached insert of the ultrasonic or sonic handpiece, and where ultrasonic or sonic energy activates irrigant released from the attached insert.

In another aspect, the distal end of the micro-cannula vibrates at a resonance frequency of greater than about 6 kHz, which frequency provides sufficient force to transport the irrigant externally and passively through the distal end of the micro-cannula.

In one aspect, the irrigant includes tissue dissolving agents, antibacterial agents, chelating agents and combinations thereof.

In a related aspect, the irrigant includes distilled water, sodium hypochlorite, EDTA, ClO₂, MTAD, HEBP, citric acid, maleic acid, chlorhexidine (CHX), green tea, triphala and combinations thereof.

In embodiments, an ultrasonic or sonic connector insert attachment configured to contain a first proximal and second distal threaded receiving slot is disclosed, where a polymer cannula positioned therein is reversibly-affixed in the first proximal threaded receiving slot by the ultrasonic or sonic connector insert attachment.

In one aspect, the ultrasonic or sonic connector insert attachment configured to connect to an ultrasonic or sonic handpiece where ultrasonic or sonic vibrations are transmitted through the polymer cannula, thereby, affording concomitant irrigation from an irrigant reservoir on the ultrasonic or sonic handpiece.

In another aspect, the ultrasonic or sonic connector insert attachment further includes a passage way that is configured to allow for a single continuous flow path of irrigant, where the flow path projects the irrigant at an external surface of the polymer cannula through an opening located proximate to the first proximal receiving slot.

Other features and advantages of the present invention will be apparent from the following more detailed description of the embodiments, taken in conjunction with the accompanying drawings which illustrate, by way of example, the principles of the invention.

The present invention together with the above and other advantages may best be understood from the following detailed description of the embodiments of the invention illustrated in the drawings.

### BRIEF DESCRIPTION OF THE DRAWINGS

FIG. 1 is a perspective view of a portion of a dental tool with a polymer cannula attached to a threaded ultrasonic insert and ultrasonic or sonic handpiece.

FIG. 2 is an enlarged perspective view of the polymer cannula attached to a threaded ultrasonic insert.

FIG. 3 is a top side view of an embodiment of the polymer cannula.

FIG. 4 is a lateral side view of an embodiment of the polymer cannula.

FIG. 5 illustrates the tip detail with lateral opening of an alternate embodiment of the present invention.

FIG. 6 is a top side view of a separate embodiment of the polymer cannula.

FIG. 7 illustrates the attachment of the two-polymer parts detail of the separate embodiment of the present invention.

FIG. 8 is a longitudinal cross-section view of the separate embodiment of the present

FIG. 9 illustrates the insert and screw direction of an embodiment of the present invention on the ultrasonic or sonic connector.

FIG. 10 depicts the irrigation fluid direction and canal content evacuation direction of an embodiment of the present invention.

FIG. 11 illustrates an embodiment of the present invention positioned inside the root canal with representations of the irrigation fluid being expressed inside the pulp chamber/root canal, and evacuation.

FIG. 12 illustrates a side view of an embodiment of the present invention.

FIG. 13 illustrates a side view of an embodiment of the present invention when attached onto a handle as support for inserting the cannula.

### DETAILED DESCRIPTION OF THE INVENTION

Before the present composition, methods, and methodologies are described, it is to be understood that this invention is not limited to particular compositions, methods, and experimental conditions described, as such compositions, methods, and conditions may vary. It is also to be understood that the terminology used herein is for purposes of describing particular embodiments only, and is not intended to be limiting, since the scope of the present invention will be limited only in the appended claims.

As used in this specification and the appended claims, the singular forms “a,” “an,” and “the” include plural references unless the context clearly dictates otherwise. Thus, for example, references to “an irrigant” include one or more irrigants, and/or compositions of the type described herein which will become apparent to those persons skilled in the art upon reading this disclosure and so forth.

Unless defined otherwise, all technical and scientific terms used herein have the same meaning as commonly understood by one of ordinary skill in the art to which this invention belongs. Any methods and materials similar or equivalent to those described herein can be used in the practice or testing of the invention, as it will be understood that modifications and variations are encompassed within the spirit and scope of the instant disclosure.

As used herein, “about,” “approximately,” “substantially” and “significantly” will be understood by a person of ordinary skill in the art and will vary in some extent depending on the context in which they are used. If there are uses of the term which are not clear to persons of ordinary skill in the art given the context in which it is used, “about” and “approximately” will mean plus or minus <10% of particular term and “substantially” and “significantly” will mean plus or minus >10% of the particular term. In embodiments, composition may “contain,” “comprise” or “consist essentially of” a particular component or group of components, where the skilled artisan would understand the latter to mean the scope of the claim is limited to the specified materials or steps “and those that do not materially affect the basic and novel characteristic(s)” of the claimed invention.

As used herein, “endodontic procedure” means a treatment sequence for the infected pulp of a tooth which is intended to result in the elimination of infection and the protection of the decontaminated tooth from future microbial invasion.

As used herein, “irrigant” (or irrigating fluid) means a fluid used in an endodontic procedure which has one or more of the following properties: broad antimicrobial spectrum; high efficacy against anaerobic and facultative microorganisms organized in biofilms; ability to dissolve necrotic pulp tissue remnants; ability to inactivate endotoxin; ability to prevent the formation of a smear layer during instrumentation or to dissolve the latter once it has formed; systemically nontoxic when they come in contact with vital tissues, non-caustic to periodontal tissues, and with little potential to cause an anaphylactic reaction, including tissue dissolving agents, antibacterial agents, chelating agents and combinations thereof. For example, MTAD (a mixture of 3% doxycycline, 4.25% citric acid, and detergent (Tween-80)); HEBP (1-hydroxyethylidene-1, 1-bisphosphonate); sodium hypochlorite, EDTA, ClO₂, citric acid, maleic acid, chlorhexidine (CHX), green tea, triphala and combinations thereof are included as examples of such irrigants.

As used herein, “lumenal” means the cavity or channel within a tube.

As used herein, “engage,” including grammatical variations thereof, means to interlock with, such as by mechanical means, chemical means and the like.

As used herein, “oblique angle” means an acute or obtuse angle.

As used herein, “annulus” means a ring-shaped object, structure, or region.

As used herein, “ultrasonic” means of or involving sound waves with a frequency above the upper limit of human hearing.

As used herein, “sonic” means denoting, relating to, or of the nature of sound or sound.

As used herein, “polymer” means a substance that has a molecular structure consisting chiefly or entirely of a large number of similar units bonded together, e.g., many synthetic organic materials used as plastics and resins.

As used herein, “effectively” means in such a manner as to achieve a desired result.

As used herein, “subject” means a person or organism that is the object of treatment.

According to an embodiment of the invention, a polymer cannula having an open proximal end, a distal end, and a slight taper along its length from the proximal end to the distal end is disclosed. The cannula includes a bored opening in its distal end or tip, so that debris of the canal can be removed through the opening. The cannula opening in the embodiment is located at the end of the distal end or tip, or in a second alternate embodiment one or two openings at the lateral surface on the last millimeters of the distal end, close to the tip.

In an embodiment, the polymer cannula is made in one single piece, being substantially cylindrical with a slight taper until the proximal end. In an alternative embodiment, the cannula can be made in two parts connected by chemical attachment, medical grade glue or over molding.

The proximal end of the cannula has a cylindrical tapered design that allows a connection to an insert to be attached to a dental tool. The insert will cooperate with the polymer cannula to transfer ultrasonic/sonic vibrations from the ultrasonic/sonic handpiece. The insert will be connected to the ultrasonic handpiece providing ultrasonic vibrations to the cannula and should deliver concomitant irrigation coming from the ultrasonic reservoir. In a preferred embodiment, the polymer cannula proximal end opening will be engaged to the insert slot, threadedly, located at the insert distal end. The insert provides irrigation passageways so the irrigation fluid will be delivered from the ultrasonic reservoir to the pulp chamber and root canal. The vibration provided and transferred to the polymer cannula will carry the irrigation fluid throughout the canal extension, alongside the cannula external surface, and be recollected at the distal end of the cannula via the described cannula opening. The proximal end of the cannula will be connected to the evacuation tubing, creating negative pressure. Depending on the configuration of the tubing, the tubing may be made from plastic, rubber, or other known materials for tubing. The negative pressure created at the distal end of the polymer cannula will provoke the dynamic unidirectional movement of the liquid from the pulp chamber to the apical third of the root canal. The proximal end of the cannula has a tube receiving projection proximate to the proximal end. The tube receiving projection has a circumferentially extending barb which cooperates with the tubing to maintain the tubing in position on the tube receiving projection.

Another aspect of the invention is directed to the polymer cannula connection for use with a dental tool. The dental tool has an energy generator positioned therein. Although this energy generator is usually an ultrasonic energy generator, other energy generators may be used, such as example a sonic energy generator. In embodiments, the polymer cannula oscillates at approximately 25-30 kHz, which allows the cannula to vibrate at an effective resonant frequency, thereby activating the irrigation liquid to provide optimum cleaning. The resonant frequency of various polymers can vary, but can be calculated, using the length of the cannula, the stiffness of the materials and the assembly, and the geometry of the tip assembly. Generally, the frequency is above 6 KHz.

The polymer cannula attaches to the dental tool insert using a self-threading connection to a metallic connector insert. The connector insert has a passage-way that provides a single continuous flow path for delivering irrigation liquid from a reservoir to the pulp chamber and root canal, projecting the fluid at the external surface of the polymer cannula through an opening located proximate to the threading housing. The insert cooperates with the polymer cannula to transfer energy from the energy generator through the insert to the cannula. The fluid has the energy imposed thereon as it passes externally in contact with the outer surface of the cannula that is being energized by the vibration from the insert/handpiece. Another aspect of the invention is directed to the polymer cannula connection for use with a dental tool. The dental tool has an energy generator positioned therein. Although this energy generator is usually an ultrasonic energy generator, other energy generators may be used, such as for example a sonic energy generator. The polymer cannula attaches to the dental tool insert using a self-threading connection to the metallic connector insert. The insert has a passage-way that provides a single continuous flow path for delivering fluid from a reservoir to the pulp chamber and root canal, projecting the fluid at the external surface of the polymer cannula through an opening located proximate to the threading housing. The insert cooperates with the polymer cannula to transfer energy from the energy generator through the insert to the cannula. The fluid has the energy imposed thereon as it passes externally in contact with the outer surface of the cannula that is being energized by the vibration from the insert/handpiece.

The invention described herein has many advantages. The polymer cannula has a single continuous evacuation path which creates negative pressure, allowing the irrigation fluid flow to reach the apical third without being extruded. The configuration of the polymer cannula assembly transfers ultrasonic vibration and energy in the plane of motion, which provides proper activation of the irrigation fluid. The use of the ultrasonic energy allows the irrigation fluid to be delivered to the root canal at a low stream velocity. As will be appreciated by those skilled in the art, the energy transferred to the irrigation fluid, especially sodium hypochlorite and EDTA, destroys microorganisms present within the root canal and dissolves organic tissue, and other debris from the affected area, thereby allowing for a more effective endodontic treatment. The dental tool insert provides continuous irrigation flow in an automated way, not requiring secondary assembly with a syringe or irrigation pump. The polymer cannula is disposable, and the dental tool connector insert can be cleaned, sterilized properly and reused.

The shaping and cleaning process is a crucial procedure in root canal treatment. The initial debridement of root canals is commonly performed by instrumentation, which removes a large bulk of the pulp tissue, necrotic debris, bacterial biofilm, or previous root canal fillings. Such removal may occur through mechanical instrumentation protocols.

Mechanical instrumentation is performed using either stainless steel hand files or engine-driven nickel-titanium (NiTi) rotary and/or reciprocation files, neither of which is expected to completely clean the canal when used alone; instead, they are used to create a space that will be filled by irrigants that will provide the cleaning effect. It seems paradoxical that the shaping process generates debris and adds more noxious volume of intracanal content that will need to be removed, but this is the most common procedure performed.

Irrigation is an essential part of root canal treatment because it enhances the debridement and disinfection of areas insufficiently cleaned by instruments. Irrigation is mainly performed by a syringe and a needle (or cannula), but this simple method is unable to clean remote areas of the root canal system Even in the main canal, instruments have been shown not to reach all areas of the canal walls. This happens because of factors related to instrument features and/or canal anatomy. For instance, preparation based on final instruments that are smaller than the initial canal diameter is expected to leave more areas untouched. As for anatomy, a curvature introduces a complexity for instrumentation because the cutting action of the instruments along the curved canal is concentrated more on some walls than on others. Consequently, some areas may remain untouched by the instruments. In addition, C-shaped and oval/flattened canals have an irregular morphology that is inconsistent with round preparations provided by rotary instrumentation systems. Therefore, unsurprisingly, canals with these morphologies exhibit a large amount of uninstrumented areas following preparation, as the instruments may not reach all recesses.

The main reason for bacterial persistence is the inability of current techniques and medications to disinfect the entire extent of the root canal system Uninstrumented areas and untouched recesses may potentially harbor remnants of bacterial biofilms. One might assume that even if the instruments fail to reach all canal walls, these areas would be permeated by NaOCl used for irrigation, which could dissolve necrotic tissue remnants and kill residual bacteria. In this case, the irrigation liquid should reach the uninstrumented areas at an effective concentration and volume and remain therein long enough for it to take effect. Current instrumentation systems fail to predictably touch all canal walls and reach these areas distant from the main canal. Therefore, there is an urgent need to develop strategies to improve infection control not only in the main canal lumen, but also in the entire root canal system

Thus, several more elaborate irrigation and activation methods have been developed. Optimized effects of chemomechanical procedures include final canal rinse with different chemical antiseptic liquids, mechanical, sonic, or ultrasonic activation of sodium hypochlorite and EDTA, photodynamic therapy, and photon-induced photoacoustic streaming using Er:YAG laser energy at subablative power levels.

Mechanical, sonic, or ultrasonic activation of sodium hypochlorite and EDTA following preparation has been recommended. Mechanical activation of irrigants has shown good results in terms of enhancing disinfection. There are also strategies that serve as an alternative to conventional chemomechanical procedures and include instruments especially designed to adjust to the root canal anatomy, system for negative pressure irrigation, and the multisonic wave system Studies shown that all aforementioned methods alone are not effective to remove tissue remains and bacteria biofilm from the uninstrumented areas following preparation.

For this reason, a procedure has arisen joining many aspects of the partially successful aforementioned techniques, as ultrasonic activation with transient cavitation, constant flow chemical repositioning, and negative pressure irrigation. With a streamlined technique of use, the method is simple, intuitive, and a low-cost application.

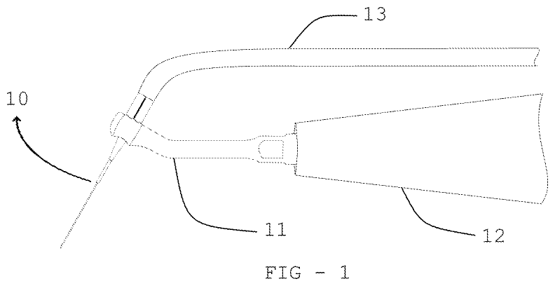

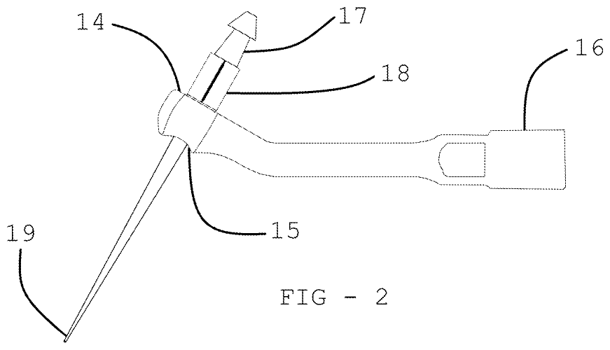

With reference to FIGS. 1 and 2, and according to the first embodiment of the present invention, a consumable high-performance polymer micro-capillary cannula 10 for use with threaded connector insert 11 for cooperating with an ultrasonic or sonic handpiece 12, a consumable commercially available evacuation tubing 13 which engages with a tube-receiving projection 17 from which tubing extends. The handpiece 12 has a proximal end that communicates with the threaded insert 11. In an embodiment, the handpiece includes an ultrasonic or sonic generator transducer (not shown) positioned in the handpiece proximate to the proximal end.

As best illustrated in FIGS. 1 and 2, a threaded insert 11 includes a proximal threaded housing with a planar surface 16 which is attached to the ultrasonic or sonic handpiece when the dental device is in operation. The threaded standard insert may be made from brass, aluminum, low carbon steel, or other metals and/or polymers which have the strength and stability characteristics to mount the ultrasonic or sonic handpiece 12 and withstand the vibration applied thereto. The polymer cannula 10 is self-threaded at the distal threaded slot 14 of the aforementioned standard insert 11.

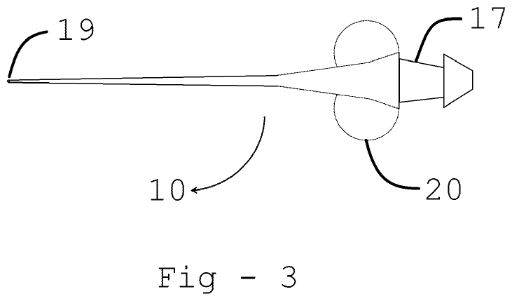

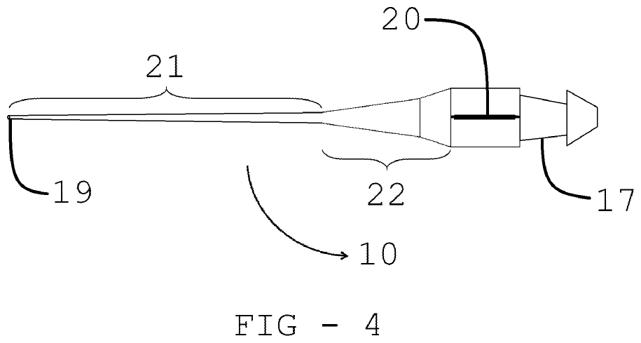

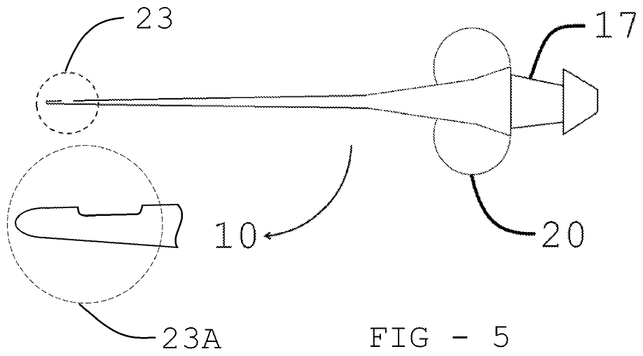

As referred in FIGS. 3 through 5, the polymer cannula 10 preferably is made from one or two polymers' types rigid enough to transmit the vibration, but flexible enough to go through the root canal curvature.

In a first embodiment, the polymer cannula 10 is made in one single polymer type. Polypropylene polymer, polyethylene polymer, polyether ether ketone (PEEK), polycarboxylate, amorphous thermoplastic polyetherimide; a polymeric alloy or XENOY® resin, which is a composite of polycarbonate and polybutylene terephthalate or LEXAN® plastic, which is a copolymer of polycarbonate and isophthalate terephthalate resorcinol resin, liquid crystal polymer, polyamide, nylon, or any other suitable resin plastic or composite that is sufficiently strong at smaller diameters can be used. From the distal 19 to proximal end 17, the polymer cannula 10 is substantially cylindrical with a slight taper 21, and an increase tapered funnel type portion 22. The proximal end has a tubing receiving projection 17. The tip 19 diameter of the cannula is preferably 0.35 (±0.25) mm at the distal end 19, increasing to the proximal end 17. The cannula opening 19 is located at the tip end on a first embodiment, but on a second alternative embodiment is located laterally 23/23A at the tip end.

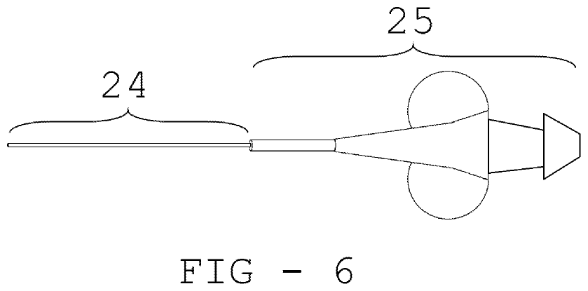

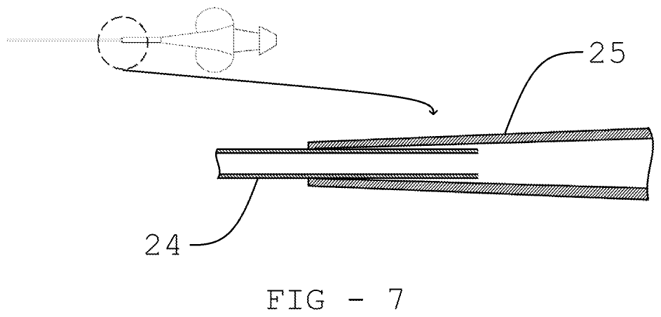

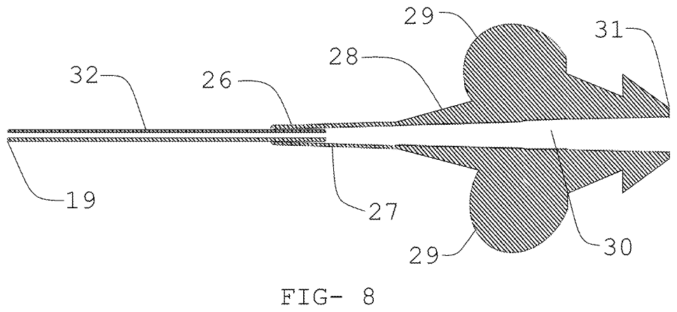

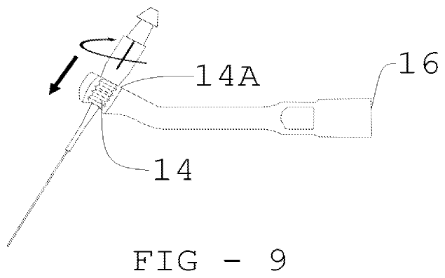

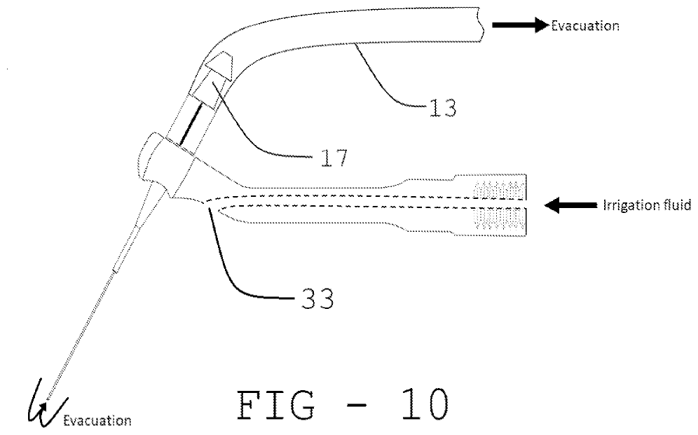

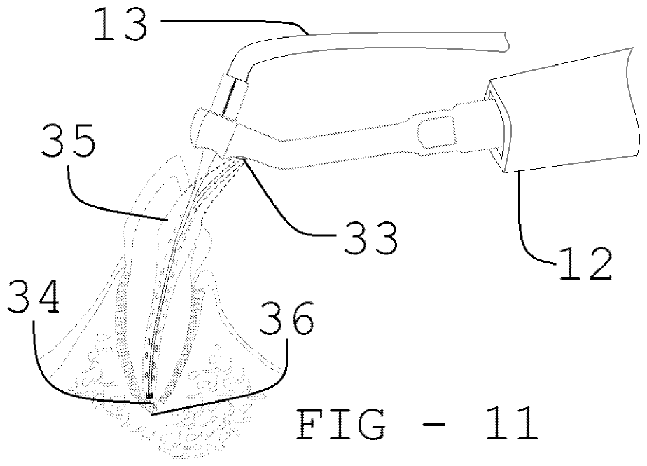

In an alternative second embodiment referred to in FIGS. 6 through 11, the polymer cannula is formed to have a generally straight format, and a generally one polymer tube 24 attached to a second polymer part 26 by means of chemical attachment, glue or over molding. In one of the embodiments, two different diameters are used, the distal end has a cylindrical non-tapered portion 24 that is attached to a second polymer portion 25 as described. Second polymer portion partially covers the proximal portion of the first cylindrical tube 26, in a tight superimposed connection. Chemical attachment, over molding or medical grade glue is used to guarantee immobilization of the two parts. The proximal second polymer portion is slightly tapered on the first 10 (±5) mm of its distal part 27 and, at the first proximal section, has funnel shape design 28 with two wing projections laterally 29, mainly used to facilitate the self-threading installation to the standard insert threading 11 slot 14. The polymer cannula has a passageway 30 which extends through the entire length of the cannula from its proximal end 31 to its distal end 19. The pathway provides a single continuous, uninterrupted flow path for suction evacuation of the canal content.

In the embodiment shown, the distal end portion of the cannula 24 is made from PEEK (Polyether ether ketone) thermoplastic high-performance biomaterial polymer, although other thermoplastic polymers can be used as well. The described second polymer distal portion 25 of the cannula is made from thermoplastic polypropylene polymer, although other thermoplastic polymers can be used as well. The cannula distal end tip 19 is blunt.

The tube receiving projection 17 is located proximate the proximal end 31 of the polymer cannula. The tube receiving projection has a circumferentially extending barb 17 which cooperates with the tubing to maintain the tubing 13 in position on the tube receiving projection 17. Tubing 13 is used to evacuate fluid and root canal content to a standard dental evacuation system. A standard commercially available vacuum connector, positioned at the end of the tubing, is attached to the standard dental unit evacuation system. The tubing 13 may also have other configurations, including but not limited to a fluid line which is positioned internally to the ultrasonic or sonic handpiece. Tubing may be manufactured from silicone, plastic or a similar material.

Before use, the connector insert 11 must be properly assembled onto the ultrasonic or sonic handpiece 12. An exemplary method for insert assembly includes the following steps. First, threaded insert 16 is threaded onto ultrasonic or sonic handpiece 12. As will be appreciated by those skilled in the art, ultrasonic handpiece is typically attached to a separate power supply and may be any of a variety of ultrasonic devices that are commercially available.

After the connector insert 11 has been assembled to the ultrasonic or sonic handpiece 12, the polymer cannula is installed by placing the cannula inside the insert threaded distal slot 14 from the top part of the insert threading slot to down, and gently self-threaded by turning the cannula clockwise until the two wing projections touch the insert distal end threading slot top surface 14A. One end of tubing 13 is attached to the tube receiving projection 17 and the other end of the tubing assembly is attached, to a dental unit evacuation system. A portion of the tubing 13 may be secured to the ultrasonic or sonic handpiece by silicone holders (not part of the invention). Silicone holders may act as a strain relief for the tubing and help to keep the tubing close to the ultrasonic or sonic handpiece, thereby preventing entanglements and kinks in the tubing.

Once the polymer cannula has been assembled to the insert 11 and tubing 13, the distal portion of polymer cannula 19 is placed within the root canal to an appropriate length in which the tip of the cannula is positioned slightly off the foramen position 34. The penetration depth should be equal or less than the working length used during the mechanical enlargement of the root canal in the mechanical instrumentation phase. The ultrasonic or sonic handpiece 12 is activated by the user at a power level ranging from 10 to 100 per cent of the full amplitude (also known as power). Ultrasonic or sonic energy passes from the handpiece 12 through the threaded insert 11 and to the cannula. The planar insert/cannula configuration acts similarly to a tuning fork. The vibrations induced by the threaded insert 11 are amplified due to the free vibration at distal end 19 of the cannula. The irrigation fluid stored at the ultrasonic or sonic unit reservoir is then pumped through the insert passageway 33 to the pulp chamber 35/root canal simultaneously with ultrasonic or sonic handpiece 12 activation. The cannula's vibration helps the irrigation fluid travel the canals' entire length, externally to the cannula's surface, up to the apical third, without, however, exerting any pressure in the apical direction, avoiding the forced extrusion of the irrigation fluid beyond the limits of the canal 36. The use of the ultrasonic or sonic energy allows the irrigation liquid to be delivered to the root canal at a relatively low stream velocity, preventing the undesired extrusion, since endodontics irrigation fluids are noxious to the organic tissues that surround the tooth, like the periodontal ligament or the apical bone 36. As will be appreciated by those skilled in the art, this energy field helps to neutralize microorganisms present within the root canal and plays as a catalyst to the chemical reactions involved in tissue dissolution and debris removal from the affected area, thereby allowing for a more efficient endodontic treatment.

Ultrasonic or sonic handpiece 12 vibrations are most effective when they are translated to the polymer cannula in a single plane. The shape of the cannula and the insert creates a geometry that generates movement of the polymer cannula's tip 19 in a direction which is planar to the longitudinal axis of the cannula. This planar motion is maintained over cycles, due to the tight self-threading cannula's surface and threaded insert relation 14, thereby allowing the motion of the ultrasonic or sonic handpiece 12 to be properly transferred to the cannula with minimal distortion.

The negative pressure exerted by the suction action achieved by connecting the tubing with the proximal end of the cannula 17, and consequently with the dental evacuation suction unit, leads the irrigation fluid dispensed externally to the cannula's surface to cover the entire root canal extension. The tip of the polymer cannula 19 will limit the penetration of the irrigation liquid and determine its penetration limit. The correct positioning of the polymer cannula up to the working length, next to the position of the apical foramen 34, controls the penetration of the irrigating fluid in the entire length of the canal, again without forcing the irrigation fluid beyond the limits of the root canal.

Additionally, the present invention is useful to dry the root canal space previously to the obturation phase by turning the handpiece off but keeping the evacuation suction on.

FIG. 1 shows the present invention 10 installed. The polymer cannula is shown screwed to the ultrasonic or sonic insert 11, the insert 11 screwed to the handpiece 12, and tubing 13 attached to the cannula 10.

FIG. 2 depicts the present invention preferred embodiment details. The distal end or tip 19, the tubing connection barbed projection on the proximal end 17, and a part 18 that contains two wing-shape projections sideways. The illustration also depicts the ultrasonic or sonic connector with the distal threaded slot top opening 14, distal threaded slot down opening 15, and the proximal end 16.

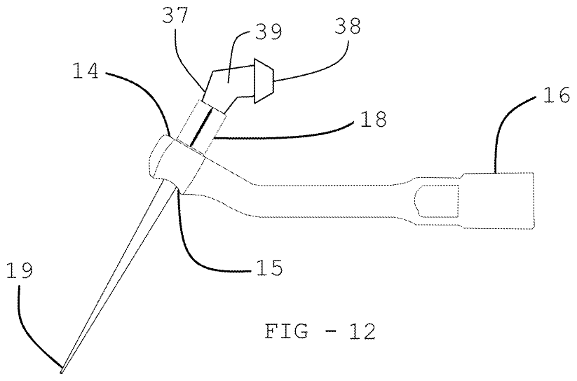

In an alternative embodiment (FIG. 12), the proximal end of the polymer cannula 18 is open to receive an approximately 120° angled polymer connector 39 that has the distal projection 37 to be inserted and fit on the polymer cannula proximal open space 18. The proximal end of the polymer angled connector 38 has a circumferentially extending barb projection which will be inserted on the distal end of the tubing. Tubing 13 is used to evacuate fluid and root canal content to a standard dental evacuation system. A connector, positioned at the proximal end of the tubing, is attached to the standard dental unit evacuation system. The tubing 13 may also have other configurations, including but not limited to a fluid line that is positioned internally to the ultrasonic or sonic handpiece. Tubing may be manufactured from silicone, plastic, or a similar material.

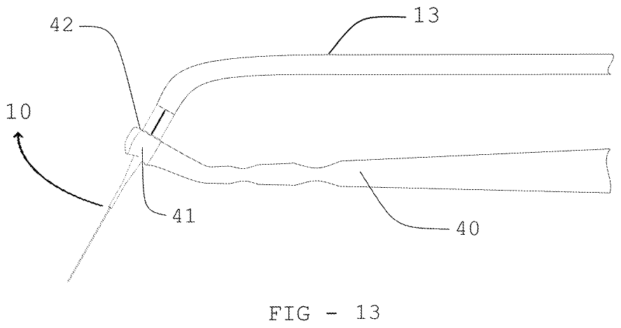

In an additional embodiment (FIG. 13), the described polymer cannula 10 will be coupled to a polymer or metal approximately 150° angled polymer or metal handle 40 that will serve as support for manually inserting the cannula in the desired position inside the root canal. The proximal end of the polymer or metal handle 41 has a threaded distal slot from the top part of the threading slot down, and gently self-threaded by turning the cannula clockwise until the two wing projections touch the handle distal end treating slot top surface 42. In this case, the polymer cannula will not be activated by the ultrasonic or sonic apparatus, but it will still generate a negative pressure inside the canal when connected to the tubing and the evacuation system, ensuring the flow of irrigating liquid from the coronal third or pulp chamber up to the working length without offering the danger of extravasation of this liquid beyond the limits of the root canal.

While exemplified embodiments of the invention have been described and illustrated above, it should be understood that these are exemplary of the invention and are not to be considered as limiting. Therefore, it is intended that the invention not be limited to the particular embodiments disclosed as the best mode contemplated for carrying out this invention, but that the invention will include all embodiments falling within the scope of the appended claims. All references are incorporated by reference herein.

We claim:

1. An endodontic micro-cannula system for evacuation of root canal contents from a root canal of a patient, said system comprising:
a microcannula having a distal end and a proximal end and a lumen extending therethrough, said distal end configured for insertion into the apical third of the root canal, said proximal end configured for fluid connection to a vacuum tube, whereby vacuum can be applied to the distal end of the microcannula;
an ultrasonic/sonic handpiece with an attached insert, said attached insert having a proximal end configured for attachment to the handpiece and a distal end configured for fixation to the proximal end of the microcannula, said handpiece configured to impart ultrasonic/sonic vibrations through the attached insert to the microcannula;
said attached insert having a lumen extending therethrough, with a distal opening proximate the proximal end of the microcannula, whereby irrigant may be delivered to the root canal proximate a coronal third of the root canal and proximal to the apical third of the root canal while a portion of the distal end of the microcannula is disposed in the apical third of the root canal.

2. The system of claim 1 wherein the handpiece is configured to impart ultrasonic/sonic vibrations in the range of 25 to 30 kHz to the microcannula.

3. The system of claim 1 further comprising:
a vacuum source for connection to the microcannula;
a source of irrigation fluid for supply of irrigation fluid through the lumen of the insert.

4. A method of evacuation of root canal contents from a root canal in a patient, said method comprising:
providing the system for evacuation of root canal contents according to claim 1;
inserting the microcannula into a root canal, so that the distal end is disposed in the apical third of the root canal
dispensing an irrigant through the lumen of the insert proximate the coronal third of the root canal while maintain the distal end of the lumen of the insert outside the root canal;
applying suction to the apical third of the root canal through the microcannula while operating the handpiece to impart ultrasonic/sonic vibration to the distal end of the microcannula.

5. A method of evacuating contents from a root canal of a patient using an endodontic micro-cannula system, the method comprising:
(a) inserting a distal end of a microcannula into an apical third of the root canal, the microcannula having a lumen extending from the distal end to a proximal end configured for connection to a vacuum source;
(b) coupling the proximal end of the microcannula to an insert having a lumen therethrough, the insert being operatively connected to an ultrasonic or sonic handpiece configured to transmit vibrational energy through the insert to the microcannula;
(c) applying a vacuum through the microcannula to evacuate root canal contents from the apical third of the root canal;
(d) activating the ultrasonic or sonic handpiece to impart vibrations to the microcannula while evacuating the root canal contents to enhance disruption and removal of root canal contents; and
(e) delivering an irrigant through the lumen of the insert such that the irrigant enters the root canal at a location proximal to the apical third and within a coronal third of the root canal, while the microcannula continues evacuating the root canal contents.
